(19) United States
(12) Patent Application Publication
(10) Pub. No.: US 2017/0106688 A1
(43) Pub. Date: Apr. 20, 2017

(54) TRANSFER RELIEF PLATE

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Peimao LI, Beijing (CN); Xuelu WANG, Beijing (CN); Zhoushuo CHU, Beijing (CN); Yanpeng XUE, Beijing (CN)

(21) Appl. No.: 15/037,528

(22) PCT Filed: Jul. 29, 2015
(86) PCT No.: PCT/CN2015/085432

§ 371 Date: May 18, 2016

(30) Foreign Application Priority Data
Apr. 16, 2015 (CN) 201510181226.0

(51) Int. Cl. B41N 1/06; G02F 1/13

(52) U.S. Cl. CPC B41N 1/06; G02F 1/1303; G02F 1/133723

(57) ABSTRACT

A transfer relief plate (02) comprises a base plate (021) which is divided into four regions having identical areas by a first axis (x) and a second axis (y). A plurality of strip-like protrusions are disposed on the base plate (021) and there is an interval between any two adjacent strip-like protrusions. The first axis (x) is in parallel with a stretching direction (x1) of the transfer relief plate (02), and the second axis (y) is in parallel with a non-stretching direction (y1) of the transfer relief plate (02). The plurality of strip-like protrusions comprise a first strip-like protrusion (022) which is disposed in any one of the four regions. An end of the first strip-like protrusion (022) close to a first side (g) of the base plate (021) is inclined to a central direction of the first side (g) of the base plate (021), the first side (g) of the base plate (021) being a side of the base plate (021) which is in parallel with the stretching direction (x1) of the transfer relief plate (02) and is close to the first strip-like protrusion (022). The transfer relief plate (02) improves uniformity of the printed PI solution.

### TECHNICAL FIELD

Embodiments of the present disclosure relate to a transfer relief plate.

### BACKGROUND

In a liquid crystal display device, an alignment film is a thin film formed on a surface of a glass substrate and configured to make liquid crystals arranged in a certain sequence. The alignment film can be formed on the surface of the glass substrate by coating polyimide solution (abbreviated to PI) onto the surface of the glass substrate and heating the coated PI solution so as to volatilize the organic solvent in the PI solution. Usually, a transfer relief plate in which PI solution is absorbed is utilized to print the PI solution onto the glass substrate, so as to achieve the coating of the PI solution. The transfer relief plate is a plate configured to print PI solution onto the glass substrate. The transfer relief plate can be an APR (Asahikasei Photosensitive Resin) plate.

In general, the transfer relief plate has a rectangular shape. When the transfer relief plate is used to print PI solution, the transfer relief plate is soaked with the PI solution, and is wrapped onto a roller and thus fixed to the roller. And then, the roller wrapped with the transfer relief plate rolls on the glass substrate, thereby printing the PI solution to the surface of the glass substrate. On the transfer relief plate, a direction in parallel with an axis of the roller is a non-stretching direction of the transfer relief plate, while a direction perpendicular to the non-stretching direction is a stretching direction of the transfer relief plate. Referring to FIG. 1, which is an illustrative structural view of a conventional transfer relief plate 01, Direction b is the stretching direction of the transfer relief plate 01 and Direction c is the non-stretching direction of the transfer relief plate 01. The transfer relief plate 01 comprises a base plate 011 having a rectangular shape. Four corners of the base plate 011 are provided with plate hanging locations d, through which the base plate 011 is fixed to the roller. A plurality of strip-like protrusions 012 are disposed on the base plate 011 and are arranged in two groups along the non-stretching direction c of the base plate 011. There is an interval between any two adjacent strip-like protrusions 012.

The above transfer relief plate at least has the following problems. When the transfer relief plate is used to wrap the roller and the roller wrapped with the transfer relief plate rolls on the glass substrate, the transfer relief plate will be stretched in the stretching direction. Since the plate hanging locations d where the transfer relief plate and the roller are fixed to each other are positioned at the four corners of the base plate, edges of the transfer relief plate which are in parallel with the stretching direction have a larger stretched degree than a central portion of the transfer relief plate, which causes a poor uniformity of the printed PI solution.

### SUMMARY

At least one embodiment of the present disclosure provides a transfer relief plate which is capable of being fixed to a surface of a roller, comprising a base plate,

the base plate is divided into four regions having equivalent areas by a first axis and a second axis, the first axis being in parallel with a stretching direction of the transfer relief plate, the second axis being in parallel with a non-stretching direction of the transfer relief plate, the non-stretching direction being parallel to a axis of the roller, the stretching direction being perpendicular to the non-stretching direction, a plurality of strip-like protrusions are disposed on the base plate and there is an interval between any two adjacent strip-like protrusions,

wherein the strip-like protrusions comprise a plurality of first strip-like protrusions which are disposed in any one of the four regions, there is an interval between any two adjacent first strip-like protrusions, one end of the first strip-like protrusion, which is close to a first side of the base plate, is inclined to a central direction of the first side of the base plate, and the first side is a side of the base plate which is in parallel with the stretching direction of the transfer relief plate and is close to the end portion of first strip-like protrusion.

In one embodiment of the present disclosure, the plurality of strip-like protrusions further comprise a second strip-like protrusion which is symmetrically disposed in two of the four regions which are on the same side of the second axis by taking the first axis of the base plate as a symmetry axis, and a center of the second strip-like protrusion protrudes in a direction away from a center of the base plate.

In one embodiment of the present disclosure, the first and second strip-like protrusions have the same lengths in the non-stretching direction.

In one embodiment of the present disclosure, the first strip-like protrusion has a multi-stepped structure in the non-stretching direction.

In one embodiment of the present disclosure, any step of the multi-stepped structure in the non-stretching direction of the transfer relief plate has a length a=L/N, wherein L is a length of the first strip-like protrusion in the non-stretching direction of the transfer relief plate, and N is the number of the steps of the multi-stepped structure.

In one embodiment of the present disclosure, the first strip-like protrusions are disposed in any one of the four regions, and in the multi-stepped structure, a distance from a first step to the first side of the base plate is smaller than a distance from a second step to the first side of the base plate, and a distance from the first step to a second side of the base plate is greater than a distance from the second step to the second side of the base plate, the second side of the base plate is a side of the base plate which is in parallel with the non-stretching direction and is close to the first strip-like protrusion, and the first step and the second step are any two adjacent steps in the multi-stepped structure of the first strip-like protrusion.

In one embodiment of the present disclosure, the base plate has a rectangular shape, and plate hanging locations are provided at four corners of the base plate.

In one embodiment of the present disclosure, the second strip-like protrusion is symmetrically disposed in two of the four regions which are on the same side of the second axis by taking being the first axis of the base plate as a symmetry axis, and the second strip-like protrusion has an arc or triangular shape.

In one embodiment of the present disclosure, the plurality of strip-like protrusions are disposed as n groups of strip-like protrusions in the non-stretching direction, wherein n is a positive integer, and each group of strip-like protrusions comprises at least two strip-like protrusions.

In one embodiment of the present disclosure, distances between any two adjacent strip-like protrusions in each group of strip-like protrusions which are disposed on the same side of the second axis are identical.

In one embodiment of the present disclosure, the strip-like protrusions are made of photosensitive resin, or alternatively, both of the strip-like protrusions and the base plate are made of photosensitive resin.

In the transfer relief plate according to the embodiments of the present disclosure, since every one of the strip-like protrusions on the transfer relief plate is inclined towards a center of a side which is adjacent thereto and is in parallel with the stretching direction of the transfer relief plate, or protrudes toward a direction away from the center of the base plate, when the roller wrapped with the transfer relief plate rolls on the glass substrate, the transfer relief plate is stretched in its stretching direction and edges of the transfer relief plate in parallel with the stretching direction have a larger stretched degree than the central portion of the transfer relief plate, so that one end of the strip-like protrusion adjacent to a side of the transfer relief plate in parallel with the stretching direction has a stretched degree equal to that of the other end of the strip-like protrusion, or so that the stretched degree of both ends of the strip-like protrusion is equal to that of the center of the strip-like protrusion. Thus, the uniformity of the printed PI solution is improved.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is an illustrative structural view of a conventional transfer relief plate;

FIG. 2 is an application scenario view of a transfer relief plate according to an embodiment of the present disclosure;

FIG. 3 is an illustrative structural view of a transfer relief plate according to an embodiments of the present disclosure;

FIG. 4 is an illustrative structural view of another transfer relief plate according to the embodiments of the present disclosure;

FIG. 5 is an illustrative structural view of one type of the first strip-like protrusions according to the embodiment as illustrated in FIG. 4;

FIG. 6 is an illustrative structural view of another type of the first strip-like protrusions according to the embodiment as illustrated in FIG. 4; and

FIG. 7 is an enlarged partial view of the transfer relief plate according to the embodiment as illustrated in FIG. 4.

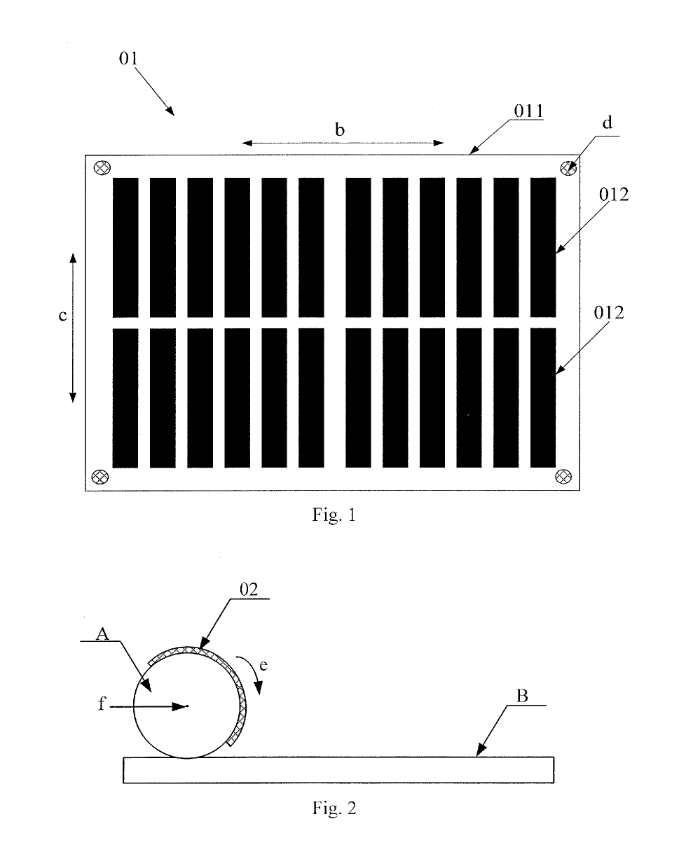

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

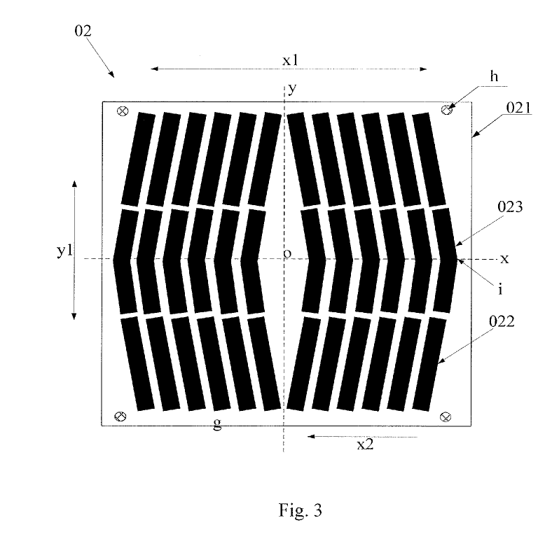

FIG. 2 illustrates an application scenario view of a transfer relief plate 02 according to one embodiment of the present disclosure. As illustrated in FIG. 2, the roller A has a cylindrical structure and the transfer relief plate 02 can be of rectangular shape having a length in the non-stretching direction (not illustrated in FIG. 2) equal to a height of the cylindrical structure and a length in the stretching direction (not illustrated in FIG. 2) smaller than a perimeter of the cylindrical structure. The transfer relief plate 02 is soaked with PI solution. The transfer relief plate 02 is wrapped onto the cylindrical surface of the roller A along the stretching direction of the transfer relief plate 02 and is fixed to the roller A at plate hanging locations (not illustrated in FIG. 2) of the transfer relief plate 02. The non-stretching direction of the transfer relief plate 02 is in parallel with an axis of the roller A. A surface of a glass substrate B can be a surface to be printed with PI solution. When the roller A wrapped with the transfer relief plate 02 rolls on the surface of a glass substrate B along a direction e as indicated in FIG. 2, the PI solution on the transfer relief plate 02 can be printed onto the surface of the glass substrate B.

In this embodiment, on the transfer relief plate 02, a direction in parallel with the axis f of the roller A is the non-stretching direction of the transfer relief plate 02 and a direction perpendicular to the non-stretching direction is the stretching direction of the transfer relief plate 02.

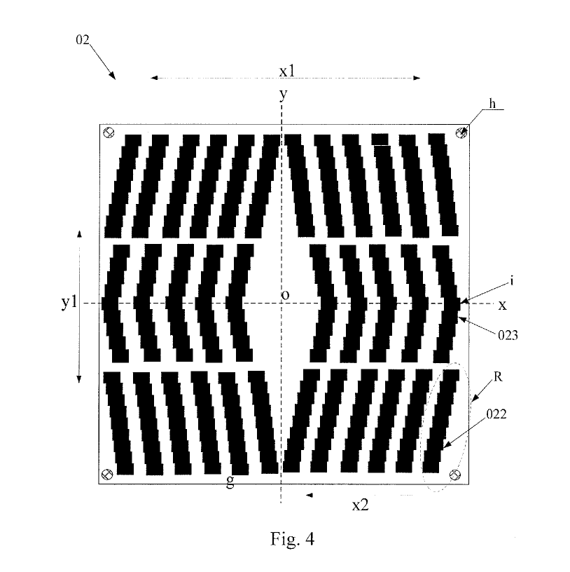

Referring to FIG. 3, which shows an illustrative structural view of the transfer relief plate 02 according to one embodiment of the present disclosure, the transfer relief plate 02 can be wrapped on the cylindrical surface of the roller. Referring to FIG. 3, the transfer relief plate 02 comprises a base plate 021 which is divided by two axes of the base plate 021 into four regions having equivalent areas. As illustrated in FIG. 3, the two axes of the base plate 021 are the first axis x and the second axis y respectively.

The first axis x of the base plate 021 is in parallel with the stretching direction x1 of the transfer relief plate. The second axis y of the base plate 021 is in parallel with the non-stretching direction y1 of the transfer relief plate. The stretching direction x1 is perpendicular to the non-stretching direction y1. A plurality of strip-like protrusions are disposed on the base plate 021 and there is an interval between any two adjacent strip-like protrusions. After the transfer relief plate 02 is fixed to the roller A, the non-stretching direction y1 is in parallel with the axis of the roller.

The plurality of strip-like protrusions comprise a first strip-like protrusion 022 which is disposed in any one of the four regions. An end of the first strip-like protrusion 022, which is close to a first side of the base plate 021, is inclined to the central direction of the first side of the base plate. The first side of the base plate 021 is a side of the base plate 021 which is in parallel with the stretching direction x1 of the transfer relief plate 02 and is close to the first strip-like protrusion 022, such as the side g in FIG. 3. The central direction of the first side of the base plate 021 is a direction x2 from one end of the side g toward the center of the side g, as illustrated in FIG. 3.

The plurality of strip-like protrusions further comprise a second strip-like protrusion 023 which is symmetrically disposed in two of the four regions on the same side of the second axis y with the first axis x of the base plate as the symmetry axis. The center of the second strip-like protrusion 023 protrudes toward a direction away from the center of the base plate 021. As illustrated in FIG. 3, the center i of the second strip-like protrusion 023 protrudes toward a direction away from the center O of the base plate 021.

It is to be noted that the base plate 021 can have a rectangular shape. Four corners of the base plate 021 are provided with plate hanging locations h of the transfer relief plate 02, where the transfer relief plate 02 is fixed to the roller. When the transfer relief plate 02 is fixed on the roller, the non-stretching direction y1 of the transfer relief plate 02 is in parallel with the direction in which the axis of the roller is located and the stretching direction x1 of the transfer relief plate 02 is perpendicular to the non-stretching direction y1 of the transfer relief plate 02.

To sum up, in the transfer relief plate according to the embodiments of the present disclosure, since every one of the strip-like protrusions on the transfer relief plate is inclined to a center of an adjacent and corresponding side in parallel with the stretching direction of the transfer relief plate or protrudes toward a direction away from the center of the base plate, when the roller wrapped with the transfer relief plate is rolled on the glass substrate, the transfer relief plate is stretched in its stretching direction and edges of the transfer relief plate in parallel with the stretching direction have a stretched degree greater than the central portion of the transfer relief plate, so that one end of the strip-like protrusion adjacent to a side of the transfer relief plate and in parallel with the stretching direction has a stretched degree equal to that of the other end of the strip-like protrusion, or so that the stretched degree of both ends of the strip-like protrusion is equal to that of the center of the strip-like protrusion. Thus, the uniformity of the printed PI solution is improved. The embodiments of the present disclosure have solved the problem of poor uniformity of PI solution printed by conventional transfer relief plates and have improved the uniformity of the PI solution.

Referring to FIG. 4, an illustrative structural view of another transfer relief plate 02 according to an embodiment of the present disclosure is illustrated. Referring to FIG. 4, the transfer relief plate 02 comprises a base plate 021.

The base plate 021 can have a rectangular shape and are provided with plate hanging locations h at four corners thereof.

The base plate 021 is divided by two axes of the base plate 021 into four regions having equivalent areas. As illustrated in FIG. 4, the two axes of the base plate 021 are the first axis x and the second axis y respectively.

The first axis x of the base plate 021 is in parallel with the stretching direction x1 of the transfer relief plate. The second axis y of the base plate 021 is in parallel with the non-stretching direction y1 of the transfer relief plate. The stretching direction x1 is perpendicular to the non-stretching direction y1. A plurality of strip-like protrusions are disposed on the base plate 021 and there is an interval between any two adjacent strip-like protrusions. After the transfer relief plate 02 is fixed to the roller A, the non-stretching direction y1 is in parallel with a direction where the axis of the roller is located.

The plurality of strip-like protrusions comprise a first strip-like protrusion 022 which is disposed in any one of the four regions. An end of the first strip-like protrusion 022, which is close to the first side of the base plate 021, is inclined to the central direction of the first side of the base plate. The first strip-like protrusion 022 is any one of the plurality of strip-like protrusions which is disposed in any one region. The first side of the base plate 021 is a side of the base plate 021 which is in parallel with the stretching direction x1 of the transfer relief plate 02 and is close to the first strip-like protrusion 022, such as the side g in FIG. 4. The central direction of the first side of the base plate 021 is a direction x2 from one end of the side g toward the center of the side g, as illustrated in FIG. 4.

The plurality of strip-like protrusions further comprise a second strip-like protrusion 023 which is symmetrically disposed in any two of the four regions on the same side of the second axis y with the first axis x of the base plate as a symmetry axis. The center of the second strip-like protrusion 023 protrudes toward a direction away from the center of the base plate 021. As illustrated in FIG. 4, the center i of the second strip-like protrusion 023 protrudes toward a direction away from the center O of the base plate 021.

In one embodiment according to the present disclosure, the first strip-like protrusions have the same lengths in the non-stretching direction y1 of the transfer relief plate 02. The lengths of the first strip-like protrusions in the non-stretching direction y1 and the lengths of the first strip-like protrusions in the stretching direction x1 are not limited in the embodiments of the present disclosure, but can be set as required in practical applications. The lengths of the second strip-like protrusions in the non-stretching direction y1 and the lengths of the second strip-like protrusions in the stretching direction x1 are not limited in the embodiments of the present disclosure, but can be set as required in practical applications.

In one embodiment according to the present disclosure, referring to FIG. 4, the first strip-like protrusion 022 has a multi-stepped structure in the non-stretching direction y1 of the transfer relief plate 02.

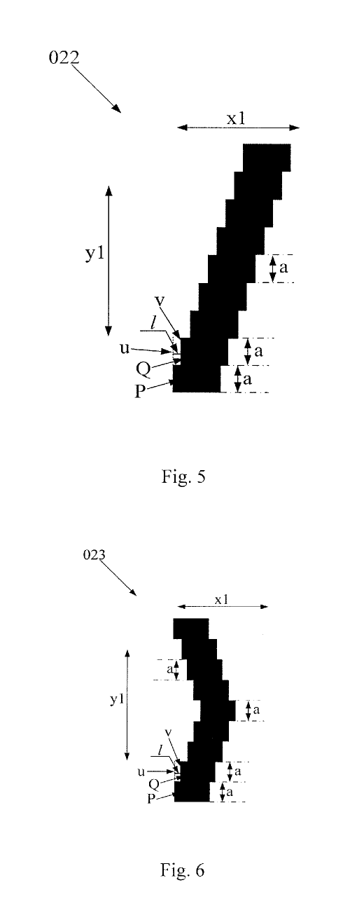

By way of example, referring to FIG. 5 which illustrates an illustrative view of a structure of the first strip-like protrusion 022 according to the embodiment as illustrated in FIG. 4, the first strip-like protrusion 022 is a strip-like protrusion disposed in any one of the four regions of the transfer relief plate 02. Referring to FIG. 5, the first strip-like protrusion 022 has a stepped structure which comprises a plurality of steps, the shape of which can be rectangular. A length of any one step in the non-stretching direction y1 of the transfer relief plate 02 can be “a”. A length of any one step in the stretching direction x1 of the transfer relief plate 02 is equal to the length of the strip-like protrusion in the stretching direction x1. The width of the step can be “l”, wherein the width of the step refers to a difference between a distance from a first step of two adjacent steps in the same one strip-like protrusion to a second side of the base plate 021 and a distance from a second step of the two adjacent steps in the same strip-like protrusion to the second side of the base plate 021, wherein the second side refers to a side of the base plate 021 which is perpendicular to the stretching direction (i.e., perpendicular to the axis x). As illustrated in FIG. 5, assuming that the first step is step P and the second step is step Q, the width of the first step P is a width l from the side u of the first step P to the side v of the second step Q.

By way of example, referring to FIG. 6, which illustrates an illustrative structural view of the second strip-like protrusion 023 according to the embodiment as illustrated in FIG. 4, the second strip-like protrusion 023 is a strip-like protrusion which is symmetrically disposed in any two of the four regions at the same side of the second axis y with the first axis x of the base plate 021 as a symmetry axis. The second strip-like protrusion 023 has an arc or triangular shape. Referring to FIG. 6, the second strip-like protrusion 023 has a stepped structure which comprises a plurality of steps, the shape of which can be rectangular. A length of any one step in the non-stretching direction y1 of the transfer relief plate 02 can be “a”. A length of any one step in the stretching direction x1 of the transfer relief plate 02 is equal to the length of the strip-like protrusion in the stretching direction x1. The width of the step can be “l”, wherein the width of the step refers to a difference between distances from two adjacent steps in the same one strip-like protrusion to a second side of the base plate 021, the second side referring to a side of the base plate 021 which is perpendicular to the stretching direction (i.e., perpendicular to the axis x). As illustrated in FIG. 6, assuming that the first step is a step P and the second step is a step Q, the width of the first step P is a width l from the side u of the first step P to the side v of the second step Q.

In this embodiment, the value of a can be a=L/N, wherein L is the length of the second strip-like protrusion 023 in the non-stretching direction y1 of the transfer relief plate 02, N is the total number of steps in the multi-stepped structure. For example, if the length of the second strip-like protrusion 023 in the non-stretching direction y1 of the transfer relief plate 02 is 40 cm and the total numbers of step N in the multi-stepped structure is 4, then the length a of any one step in the non-stretching direction y1 of the transfer relief plate 02 is 10 cm.

In this embodiment, the value of l can be set as required in practical applications, and in each step, the value of l is not limited in the embodiments of the present disclosure, but can be identical or different. In general, the glass substrate comprises a display region which is usually located in the central portion of the display panel and a non-display region which is located at the periphery of the display panel. The display region of the glass substrate is to be printed with PI solution. In the embodiments of the present invention, any one of the strip-like protrusions in the transfer relief plate 02 can print PI solution on a plurality of glass substrates simultaneously. That is to say, one strip-like protrusion can correspond to a plurality of glass substrates at the same time. Therefore, during printing PI solution, the non-display region of the glass substrate will be printed with PI solution. In the embodiments of the present disclosure, the PI solution disposed beyond the display region is called as Edge Margin (EM) data. The size of the EM data is the size of the PI solution disposed beyond the display region. The EM data typically includes data around the display region and the value of the EM data can comprise values in four directions of the display region, i.e., an upper direction, a lower direction, a left direction and a right direction, of the display region. Since the plate hanging locations of the transfer relief plate are provided at four corners of the transfer relief plate, the printed data is not uniform and thus the EM data is not uniform. On the glass substrate, the amount of the EM data is greater in areas close to the plate hanging locations, while the amount of the EM data is less in areas close to the central portion of the transfer relief plate. Therefore, in the embodiments of the present disclosure, the value of l can be determined according to the magnitude of data in the areas close to the plate hanging locations and the magnitude of data in the areas close to the central portion of the transfer relief plate, so as to avoid nonuniformity of the printed EM data.

Alternatively, a plurality of strip-like protrusions are arranged as n groups of strip-like protrusions in the non-stretching direction y1, wherein n is a positive integer. Each group of strip-like protrusions comprises at least two strip-like protrusions. Any two adjacent strip-like protrusions in each group of strip-like protrusions which are disposed on the same side of the second axis have the same interval. The value of n is not restricted in the embodiments of the present disclosure, but can be set as required in practical applications. By way of example, as illustrated in FIG. 4, which illustrates an example in which n is 3, that is, the plurality of strip-like protrusions are set as 3 groups of strip-like protrusions in the non-stretching direction y1. It is seen from FIG. 4 that each group of strip-like protrusions comprises 12 strip-like protrusions and any two adjacent strip-like protrusions in each group of strip-like protrusions which are disposed on the same side of the second axis y have the same interval.

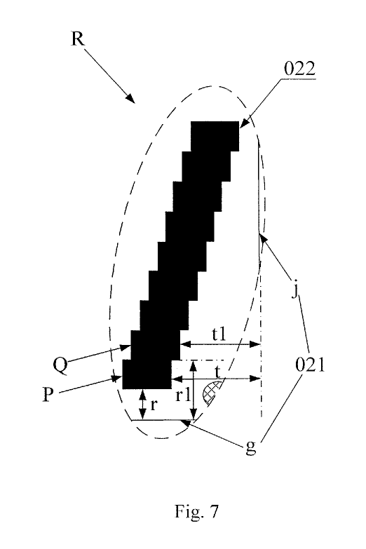

Further, referring to FIG. 7, which illustrates an enlarged view of the zone R of the transfer relief plate 02 as illustrated in FIG. 4, a multi-stepped structure of the first strip-like protrusion 022 is contained in the enlarged view. Referring to FIG. 7, in the multi-stepped structure of the first strip-like protrusion 022, a distance from the first step P to the first side g of the base plate 021 is less than a distance from the second step Q to the first side of the base plate 021, and a distance from the first step P to the second side j of the base plate 021 is greater than a distance from the second step Q to the second side of the base plate 021. The first side g of the base plate 021 is a side of the base plate 021 which is in parallel with the stretching direction of the transfer relief plate 02 and is close to the first strip-like protrusion 022. The second side j of the base plate 021 is a side of the base plate 021 which is in parallel with the non-stretching direction of the transfer relief plate 02 and is close to the first strip-like protrusion 022. The first step P and the second step Q are any two adjacent steps in the multi-stepped structure. By way of example, a distance r from the first step P to the first side g of the base plate 021 is less than a distance r1 from the second step Q to the first side g of the base plate 021, and a distance t from the first step P to the second side j of the base plate 021 is greater than a distance t1 from the second step Q to the second side j of the base plate 021.

It should be noted that in the embodiments of the present disclosure, the strip-like protrusions 022 and the strip-like protrusions 023 can be made of photosensitive resin. Alternatively, all of the strip-like protrusions 022 and 023 and the base plate 021 can be made of photosensitive resin. The photosensitive resin can be APR or other photosensitive materials, it is not restricted in the embodiments of the present disclosure.

To sum up, in the transfer relief plate according to the embodiments of the present disclosure, since every one of the strip-like protrusions on the transfer relief plate is inclined to a center of a side which is adjacent to the strip-like protrusion and in parallel with the stretching direction of the transfer relief plate, or protrudes toward a direction away from the center of the base plate, when the roller wrapped with the transfer relief plate is rolled on the glass substrate, the transfer relief plate is stretched in its stretching direction and edges of the transfer relief plate in parallel with the stretching direction have a greater stretched degree than the central portion of the transfer relief plate, so that one end of the strip-like protrusion adjacent to a side of the transfer relief plate in parallel with the stretching direction has a stretched degree equal to that of the other end of the strip-like protrusion, or so that the stretched degree of both ends of the strip-like protrusion is equal to that of the center of the strip-like protrusion. Thus, the uniformity of the printed PI solution is improved. The embodiments of the present disclosure have solved the problem of poor uniformity of PI solution printed by the current transfer relief plates and have improved the uniformity of the PI solution.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201510181226.0 filed on Apr. 16, 2015, the disclosure of which is hereby entirely incorporated by reference as a part of the present disclosure.

1. A transfer relief plate which is fixable to a side face of a roller, comprising a base plate,
wherein the base plate is divided into four regions with identical areas by a first axis and a second axis, a plurality of strip-like protrusions are disposed on the base plate and there is an interval between any two strip-like protrusions, the first axis is in parallel with a stretching direction of the transfer relief plate, the second axis is in parallel with a non-stretching direction of the transfer relief plate, the stretching direction is perpendicular to the non-stretching direction, and
wherein the strip-like protrusions comprise a first strip-like protrusion which is disposed in any one of the four regions, an end of the first strip-like protrusion close to a first side of the base plate is inclined to a central direction of the first side of the base plate which is a side of the base plate which is in parallel with the stretching direction of the transfer relief plate and is close to the first strip-like protrusion,

2. The transfer relief plate according to claim I, wherein the strip-like protrusions further comprise a second strip-like protrusion which is symmetrically disposed in two regions at the same side of the second axis with the first axis as symmetry axis, and a center of the second strip-like protrusion protrudes toward a direction away from a center of the base plate.

3. The transfer relief plate according to claim 1, wherein the plurality of strip-like protrusions have the same length in the non-stretching direction.

4. The transfer relief plate according to claim 1, wherein the first strip-like protrusion has a multi-stepped structure in the non-stretching direction.

5. The transfer relief plate according to claim 4, wherein any one step of the multi-stepped structure in the non-stretching direction of the transfer relief plate has a length a=L/N, wherein L is a length of the first strip-like protrusion in the non-stretching direction of the transfer relief plate, N is a total number of steps in the multi-stepped structure.

6. The transfer relief plate according to claim 4, wherein in the multi-stepped structure of the first strip-like protrusions, a distance from a first step to the first side of the base plate is less than a distance from a second step to the first side of the base plate, and a distance from the first step to a second side of the base plate is greater than a distance from the second step to the second side of the base plate, the second side of the base plate is a side of the base plate which is in parallel with the non-stretching direction and is close to the first strip-like protrusion, and the first step and the second step are any two adjacent steps in the multi-stepped structure of the first strip-like protrusion.

7. The transfer relief plate according to claim 1, wherein the base plate has a rectangular shape, and plate hanging locations are provided at four corners of the base plate.

8. The transfer relief plate according to claim 2, wherein the second strip-like protrusion is symmetrically disposed in two regions at the same side of the second axis with the first axis as symmetry axis, and the second strip-like protrusion has an arc or triangular shape.

9. The transfer relief plate according to claim 1, wherein the plurality of strip-like protrusions are arranged as n groups of strip-like protrusions in the non-stretching direction, wherein n is a positive integer, and each group of strip-like protrusions comprises at least two strip-like protrusions.

10. The transfer relief plate according to claim 9, wherein any two adjacent strip-like protrusions in each group of strip-like protrusions which are disposed at the same side of the second axis have an identical interval.

11. The transfer relief plate according to claim 1, wherein the strip-like protrusions are made of photosensitive resin, or alternatively, both of the strip-like protrusions and the base plate are made of photosensitive resin.

12. The transfer relief plate according to claim 2, wherein the plurality of strip-like protrusions have the same length in the non-stretching direction.

13. The transfer relief plate according to claim 2, wherein the first strip-like protrusion has a multi-stepped structure in the non-stretching direction.

14. The transfer relief plate according to claim 3, wherein the first strip-like protrusion has a multi-stepped structure in the non-stretching direction.

15. The transfer relief plate according to claim 6, wherein in the multi-stepped structure of the first strip-like protrusions, a distance from a first step to the first side of the base plate is less than a distance from a second step to the first side of the base plate, and a distance from the first step to a second side of the base plate is greater than a distance from the second step to the second side of the base plate, the second side of the base plate is a side of the base plate which is in parallel with the non-stretching direction and is close to the first strip-like protrusion, and the first step and the second step are any two adjacent steps in the multi-stepped structure of the first strip-like protrusion.

16. The transfer relief plate according to claim 2, wherein the base plate has a rectangular shape, and plate hanging locations are provided at four corners of the base plate.

17. The transfer relief plate according to claim 3, wherein the base plate has a rectangular shape, and plate hanging locations are provided at four corners of the base plate.

18. The transfer relief plate according to claim 3, wherein the second strip-like protrusion is symmetrically disposed in two regions at the same side of the second axis with the first axis as symmetry axis, and the second strip-like protrusion has an arc or triangular shape.

19. The transfer relief plate according to claim 2, wherein the plurality of strip-like protrusions are arranged as n groups of strip-like protrusions in the non-stretching direction, wherein n is a positive integer, and each group of strip-like protrusions comprises at least two strip-like protrusions.

20. The transfer relief plate according to claim 3, wherein the plurality of strip-like protrusions are arranged as n groups of strip-like protrusions in the non-stretching direction, wherein n is a positive integer, and each group of strip-like protrusions comprises at least two strip-like protrusions.
